(19) United States
(12) Patent Application Publication
(10) Pub. No.: US 2010/0124676 A1
(43) Pub. Date: May 20, 2010

(54) MANAGING GAS BUBBLES IN A LIQUID FLOW SYSTEM

(76) Inventors: John E. Meschter, New York, NY (US); James K. Prueitt, Ballston Lake, NY (US); Paul Bishop, Gansevoort, NY (US); Robert Miller, Delmar, NY (US); Karen Thatcher, East Berne, NY (US); Bryan Grygus, Clifton Park, NY (US); Michael Chen, Cambridge, MA (US); Zhigang Qi, Schenectady, NY (US)

Correspondence Address: CESARI AND MCKENNA, LLP, 88 BLACK FALCON AVENUE, BOSTON, MA, 02210, US

(21) Appl. No.: 12/274,446

(22) Filed: Nov. 20, 2008

(51) Int. Cl. B01D 19/00; H01M 8/04

(52) U.S. Cl. 429/12; 95/260; 95/254; 96/220

(57) ABSTRACT

A system and method for managing gas bubbles in a liquid flow system are described. In particular, according to the system and method, novel techniques reduce a volume of cavities in the liquid flow system and limit a cross-sectional area of the liquid flow system to a maximum cross-sectional area of tolerably sized bubbles. In this manner, by reducing the cavity volumes and limiting cross-sectional areas, the formation of intolerably sized bubbles and the aggregation of tolerably sized bubbles into intolerably sized bubbles are each substantially prevented. Also, bubbles may be removed from the system to reduce the quantity of bubbles that are to be managed.

### BACKGROUND OF THE INVENTION

1. Field of the Invention

This invention relates generally to liquid flow systems, and, more particularly, to managing bubble sizes in liquid flow systems.

2. Background Information

There are many types of devices that are configured to receive liquid that are sensitive to bubbles within the liquid. For instance, bubbles may form that are intolerably large in size, and may cause problems for the liquid receiving device, whose degree of severity varies with the particular type of liquid receiving device and the occurrence of bubbles within the liquid flow to that device.

One example device sensitive to bubbles in liquid flow are electrochemical energy conversion devices, such as fuel cells. Many fuel cell systems utilize pumps to move fluids/liquids within the system, e.g., from a reactant/fuel source to the fuel cell. Various types of pumps are well known to those skilled in the art. Often, these pumps may generate gases, which, under certain conditions of the reactant, such as temperature, pressure, viscosity, and the saturation state, may evolve into gas bubbles that occupy volume in an exit stream from the pump that would otherwise be occupied by liquid reactant. For example, electroosmotic (EO) pumps may generate some gases during the process of moving fluids such as water and methanol. Other causes of bubbles, such as mechanical, thermal, chemical, and electrical causes may also create bubbles within the liquid reactant flow system.

As a consequence, in a reactant flow system (or “feed manifold”) to a fuel cell, the gas bubbles represent voids or absences of the reactant in the reactant (fuel) flow. This leads to dropouts in the fuel cell power generation, such dropouts being proportional in their severity to the size of the bubbles, and the amount of time that passes before the fuel line begins to again deliver liquid reactant (e.g., methanol fuel) to the electrochemical energy conversion device (e.g., fuel cell). In particular, the gas bubbles at the fuel cell (device 150), while possibly being a gaseous reactant, generally have a much lower energy density (e.g., negligible) than the liquid reactant (e.g., gaseous hydrogen or vapor methanol versus liquid methanol), so if the bubble is particularly large, it may be minutes before reactant again reaches the fuel cell (due to a slow rate of fuel delivery). Larger bubbles are particularly burdensome for the flow system 100.

In addition, many other liquid receiving devices are also sensitive to bubbles in the liquid flow, such as various medical devices, paint supply systems, power plants, etc. Air bubbles flowing within a medical device may have particularly severe consequences, such as fatality of a patient or other less sever outcomes, as may be appreciated by those skilled in the art. Also, paint supply systems may suffer from bubbles, such as where finely detailed paint projects (e.g., automotive finishes) may become uneven, costing time and money to remedy the situation.

Moreover, bubbles passing through any flow measuring device for these systems may generate perturbations in the flow measurement, making such measurements more difficult and less precise. This is particularly true at low liquid flow rates, such as those typically found in reactant for a low power direct oxidation fuel cell (e.g., 1 cubic centimeter per hour). Often, such flow measurements are used to control operation of the pumps, to accommodate for changes in the flow. However, with difficulty properly determining the flow, and by not reacting quickly enough (slow feedback), the pump may not only frequently adjust its settings in an attempt to cope with flow fluctuation caused by the bubbles, but may also be potentially out of synchronization with the actual amount of liquid reaching the receiving device. These constant flow changes, in addition, may cause undue damage to the pumps over time. Also, the increased stresses on the pump may create more bubbles, leading to worse fluctuations in flow.

Various schemes have been attempted to eliminate the bubbles, such as by separating the gas (bubbles) from the liquid, separating the liquid from the gas, shunting the liquid by gravitometric or centrifugal traps and so on. In all cases, the complexity of the mechanisms, the additional flow path, and the ability of the scheme to accommodate a wide range of gas content in the fluid stream are less than sufficient to provide a smooth and continuous flow of liquid, e.g., reactant to a fuel cell, or other liquid to other types of systems. There remains a need, therefore, for efficient management of gas bubbles in a liquid flow system.

### SUMMARY OF THE INVENTION

The present invention is directed to techniques for managing (or mitigating) gas bubbles in a liquid flow system. According to the one aspect of the present invention, novel systems and methods may be used to reduce a volume of cavities in the liquid flow system and limit a cross-sectional area of the liquid flow system to a maximum cross-sectional area of tolerably sized bubbles. In this manner, by reducing the cavity volumes and limiting cross-sectional areas, the formation of intolerably sized bubbles and the aggregation of tolerably sized bubbles into intolerably sized bubbles are each substantially prevented.

In other words, according to one aspect of the novel invention, the presence of bubbles in the liquid flow system is accepted, but techniques are in place to minimize the effect of the bubbles on uniform liquid flow by dividing the gas bubbles as finely as possible and distributing the bubbles as uniformly as possible throughout the liquid. As such, a substantially reduced likelihood of intolerably sized bubbles exists in the liquid flow. For example, according to an embodiment described herein, long dropout periods where no liquid reactant is reaching an electrochemical energy conversion device, e.g., fuel cell, may be alleviated accordingly.

In addition, while formation of intolerably sized bubbles and the aggregation of tolerably sized bubbles into intolerably sized bubbles are each substantially prevented, provisions may be in place to accumulate and remove/release any intolerably sized bubbles from the liquid flow system. Thus, fewer bubbles need be managed by the other techniques described herein.

Advantageously, the novel system manages bubbles in a liquid flow system. In particular, by substantially preventing formation of intolerably sized bubbles and aggregation of tolerably sized bubbles into intolerably sized bubbles, the novel technique provides solutions to various problems associated with bubbles in liquid flow systems. For example, finely divided and distributed bubbles in the liquid reactant flow of a fuel cell have been demonstrated to reduce power fluctuations in the presence of given gas amounts within the liquid as contrasted with such amounts of gas agglomerating into one or more large bubbles that pass at one time through the system. In addition, the highly distributed and finely divided bubbles create smaller perturbations on the flow measurement of the liquid flow, enabling more precise control.

### BRIEF DESCRIPTION OF THE DRAWINGS

The above and further advantages of the invention may be better understood by referring to the following description in conjunction with the accompanying drawings in which like reference numerals indicate identically or functionally similar elements, of which:

FIG. 1 is a simplified schematic illustration of one embodiment of a liquid flow system that may be advantageously used with the present invention;

FIG. 2 is a schematic illustration of one embodiment of a flow channel that may be advantageously used with the present invention;

FIG. 3 is a schematic illustration of one embodiment of micro flow channels that may be advantageously used with the present invention;

FIG. 4 is a schematic illustration of one embodiment of volume-reduced flow channels that may be advantageously used with the present invention;

FIG. 5 is a schematic illustration of one embodiment for capillary pathways that may be advantageously used with the present invention;

FIG. 6 is a schematic illustration of one embodiment for a flow system with a break-up device that may be advantageously used with the present invention;

FIG. 7 is a flowchart illustrating a procedure for managing gas bubble size in a liquid flow system in accordance with one or more embodiments of the present invention;

FIGS. 8A-D are schematic illustrations of one embodiment for a flow system with a bubble accumulation and removal chamber that may be advantageously used with the present invention;

FIG. 9 is a flowchart illustrating another procedure for managing gas bubbles in a liquid flow system in accordance with one or more embodiments of the present invention;

FIG. 10 is a schematic illustration of one embodiment of a micro porous flow channel that may be advantageously used with the present invention; and

FIG. 11 is a flowchart illustrating another procedure for managing gas bubbles in a liquid flow system in accordance with one or more embodiments of the present invention.

### DETAILED DESCRIPTION OF AN ILLUSTRATIVE EMBODIMENT

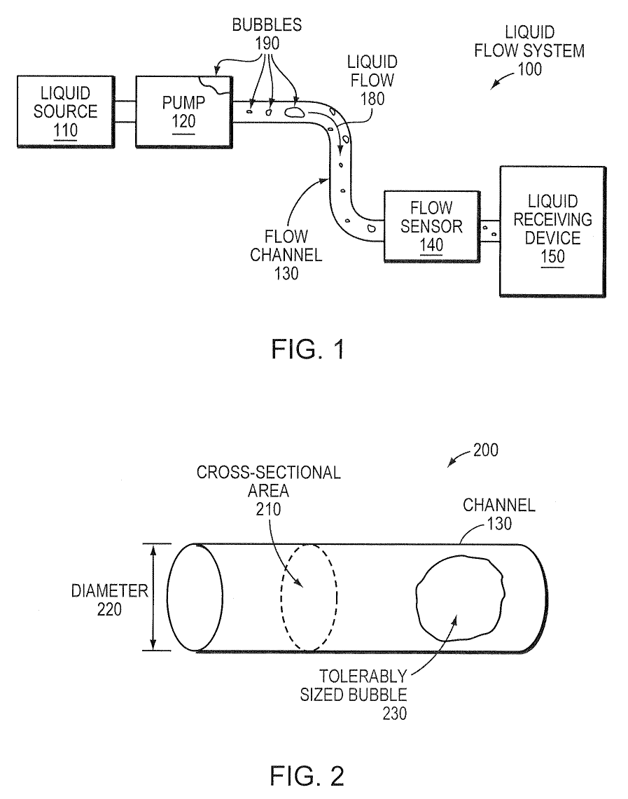

FIG. 1 is a simplified schematic illustration of one embodiment of a liquid flow system 100 that may be advantageously used with the present invention. The system 100 comprises a liquid source 110 interconnected to a liquid receiving device 150 via flow channel/conduit 130 through which liquid 180 may flow. To move the liquid, a pump 120 (e.g., electrical, mechanical, etc.) may be placed along the flow channel 130. Also, one or more flow sensors 140 may be placed along the flow channel 130 to monitor various conditions of the flow, such as rate, volume, temperature, pressure, etc.

Illustratively, the liquid receiving device 150 is an electrochemical energy conversion device or fuel cell system, e.g., a direct oxidation fuel cell, direct methanol fuel cell (DMFC), liquid or vapor feed fuel cell (fed by liquid in flow channel 130), portable fuel cell, transportable reformer-based fuel cell system, or other devices powered by a liquid fuel or other reactant, as will be understood by those skilled in the art. Notably, while an example receiving device 150 is a fuel cell, the techniques described herein are applicable to other liquid receiving devices that may be sensitive to bubbles in the liquid flow, and the illustrative example of a fuel cell should not be limiting on the scope of the present invention. Moreover, the system 100 embodying the invention may include a number of other components, or may omit certain components shown (including but not limited to conduits, interfaces, cartridges, and/or pumps) while remaining within the scope of the present invention. The example view shown herein is for simplicity, and is merely representative.

Also, the illustrative embodiment of the invention describes liquid and its use within system 100 generally, such as in fluid form. However, it should be understood that the liquid itself may be in the form of a higher viscosity liquid (e.g., gel), a liquid, or a combination of any of these fluidic forms, and the invention is not limited to use with any particular type and/or form. Also, the liquid may change from one form to another through the system, such as storing a supply of liquid to be vaporized for introduction to a receiving device 150 (e.g., a vapor-feed fuel cell, etc.).

As noted, certain components of the system 100 may generate gases, such as from pumps 120 (e.g., due to cavitations from mechanical pumps), which may evolve into gas bubbles 190 under certain conditions of the liquid 180 (temperature, pressure, viscosity, saturation state, etc.). Other causes, such as electrical, mechanical, chemical, and thermal causes within the liquid flow system may also cause bubbles. The bubbles 190 may occupy volume in the flow channel 130 that would otherwise be occupied by liquid 180, thus creating voids or absences of the liquid in the flow channel 130. As mentioned above, these bubbles 190 lead to various problems in the system 100, such as dropouts in power generation (at device 150 when illustrative a fuel cell), difficulties in flow measurement (sensor 140), notably causing damage to the pumps 120, as well as possible creation of more bubbles 190.

According to one embodiment of the novel invention, the presence of bubbles 190 in the liquid flow system 100 is accepted, but techniques are in place to minimize the effect of the bubbles on uniform flow by dividing the gas bubbles as finely as possible and distributing the bubbles as uniformly as possible throughout the liquid, so that there is a substantially reduced likelihood of intolerably sized bubbles (for example, causing a long dropout period in fuel cells where no liquid reactant is reaching the fuel cell). In particular, the novel techniques described herein are directed to substantially preventing formation of intolerably sized bubbles and aggregation of tolerably sized bubbles into intolerably sized bubbles. That is, simply preventing bubbles from forming may not be sufficient, since bubbles may reform and/or collect and rejoin further down the flow system 100.

In order to achieve this desirable outcome, the flow path (channel 130) from the reactant source 110 (more particularly, from the pump 120) to the receiving device 150 is carefully designed so that there are no cavities in which bubbles can collect, and no channels whose diameter is greater than the largest tolerable bubble diameter. Cavities, generally, are defined as a region of space within the system 100 occupying a volume that is not necessary or beneficial to the liquid flow 180. For instance, portions of the system 100 may have a greater volume than the smallest flow channel, thus allowing for liquid 180 and/or bubbles 190 to collect within the cavity volumes. Example cavities often exist within the pump 120 and at various joints of the flow channel 130.

Illustratively, the flow channels 130 may have cross-sectional areas limited to a maximum cross-sectional area of tolerably sized bubbles. For instance, FIG. 2 illustrates a simplified schematic illustration of system 200 having a portion of a flow channel 130 showing cross-sectional area 210, and a diameter 220. (Note that where diameter is used, the implied meaning is simply a distance across the channel 130. As such, while a cylindrical channel is shown, other shapes, regular or irregular, may be used with the teachings described herein, such as square, hexagonal, etc., and the use of a circular cross-section and associated diameter are merely illustrative examples.) Assuming that a tolerably sized bubble 230 has a known (configured/planned) cross-sectional area, cross-sectional area 210 of the flow channel 130 may be designed such that it is limited to that of the tolerably sized bubble 230. For example, an illustrative diameter 220 of the flow channel may be between fifteen (15) and twenty (20) thousandths of an inch.

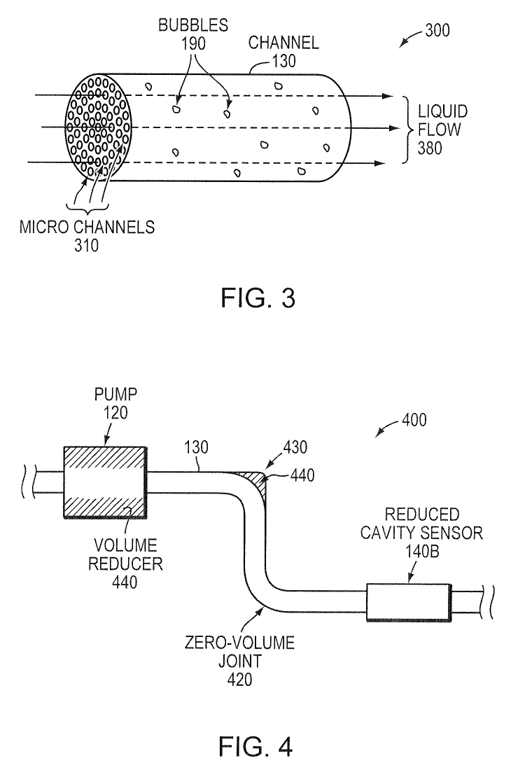

Further, due to the reduced size of the flow channel, which may become clogged or substantially reduce liquid flow (depending on how much of a reduction in size is the diameter 220), one or more embodiments of the present invention combine a plurality of micro channels into a large conglomerate flow channel. For instance, FIG. 3 illustrates a system 300 having a flow channel 130 comprising a plurality of micro channels 310, each sized appropriately to prevent intolerably sized bubbles. The reactant flow 380 through the micro channels 310 is substantially similar to the flow 180 through a conventional flow channel 130 (e.g., of FIG. 1), however the divisions created by the micro channels 310 maintain a plurality of corresponding “micro liquid flows” 380, each individually separated from one another to prevent bubbles 190 from multiple channels 310 from combining.

Another design feature that may be used to reduce cavity volumes within the flow channel 130 is to manufacture the system 100 and flow channels 130 with reduced cavity volumes. For example, FIG. 4 illustrates portions of a liquid flow system 100 with reduced cavity volumes. In particular, flow channel 130 may be designed with joints 420 having substantially no stagnant volume and very small swept volume (e.g., “zero-volume” or “0-volume” joints 420). A zero-volume joint 420, for example, may be a fixture or component that interconnects or redirects liquid flow 180 without creating additional (and unnecessary) volume. For instance, typical 90-degree square “elbow” joints, as will be appreciated by those skilled in the art, actually create a cavity at the crest or peak of the bend, such as the top joint 430 in FIG. 4 (shown with volume-reducer 440, described below). To remove the cavity, a zero-volume joint 420 may be designed and utilized that removes this excess volume from the flow channel 130, leaving no available room for tolerably sized bubbles to accumulate and aggregate into intolerably sized bubbles. Also, in addition to appropriately designing the reactant flow channels 130, other components of the system may also be designed with reduced cavities, such as flow sensor 140B. (Note further, that the length of flow channels 130 may also be shortened, thus reducing the volume in which bubble generation and accumulation may occur.)

In addition, according to one or more embodiments of the present invention, where it is not possible (or simple, or desired, etc.) to eliminate a cavity volume where bubbles 190 might collect through design, such as in the cavities of commercial devices such as the pump 120 itself, the volume may be filled with a volume-reducing material (“volume reducer”). For instance, if there are any cavities (e.g., those that cannot be eliminated through design/manufacture as mentioned above), those cavities may be filled with the volume-reducing material to reduce the volume of the cavities, accordingly. By reducing the cavity volumes in system 100, areas in which smaller bubbles may accumulate and aggregate (combine) into intolerably sized bubbles are reduced and/or eliminated.

Referring again to FIG. 4, flow system 400 may also comprise volume reducer 440 strategically placed in cavities, such as within the pump 120, in certain joints/areas 430 of the flow channel 130 (as noted above), etc. Note that while the volume reducer 440 is shown in certain configurations/locations within the system 400, such locations are merely a simplified example, and are not meant to signify actual locations or configurations, and are not meant to be to scale. For example, an outlet (exit plenum) of the pump 120 may have a large chamber, as may be appreciated by those skilled in the art, and the volume reducer 440 is used to fill the cavity volumes of the large chamber and to divide the bubbles exiting the pump into tolerably sized bubbles.

In one embodiment described herein, the volume-reducing material allows for flow of liquid and gas, such as through capillary micro pathways, but divides the liquid/gas, and more particularly, divides any bubbles, and keeps any small bubbles from aggregating into larger bubbles. Example volume-reducing material may comprise, inter alia, frit, open-cell foam, fibrous material, sintered polyethylene, etc. Frit, generally a loose powder or very fine porous block (e.g., ceramic), may be created by heating dust/beads for fusion into a porous material. Also, fibrous material may comprise wick felt, cotton wool, or other known fibrous material, particularly that is acceptable for use within a particular flow system 100 (e.g., within particular chemicals, solvents, reactants, etc.). Illustratively, the volume-reducing material (e.g., the frit) may comprise a grain size substantially smaller than a tolerably sized bubble, that is, to reduce the likelihood that bubbles larger than a tolerably sized bubble (i.e., intolerably sized bubbles) will have the opportunity to form.

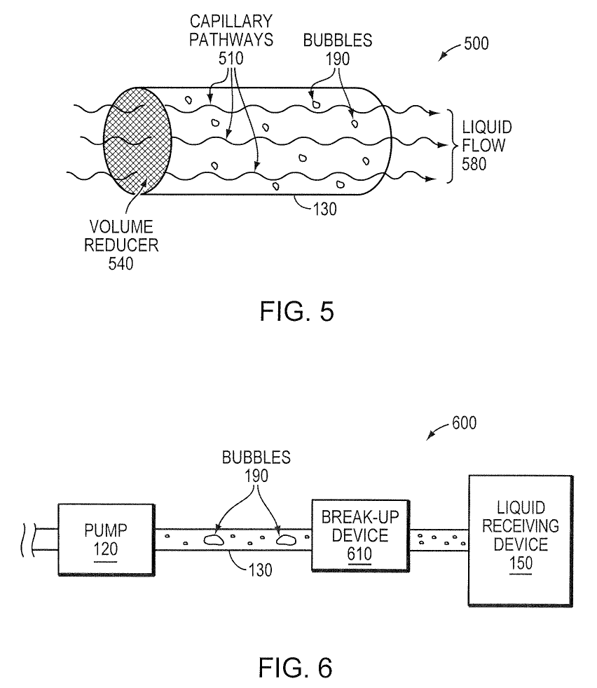

Due to the micro capillary pathways formed by certain volume-reducing materials (e.g., frit, foam, etc.), it may also be beneficial to dispose the volume-reducing material within the flow channel(s) 130 of the liquid flow system 100. For instance, FIG. 5 illustrates a simplified schematic diagram of a system 500 having a flow channel 130 substantially filled with volume-reducer 540. In this manner, liquid flow 580 may traverse a series of micro capillary pathways 510 that are formed by the volume-reducer 540 in a similar manner to the micro channels 310 above. Bubbles 190 again may be dispersed throughout the channel 130, and kept separate to prevent combination into larger, e.g., intolerably sized, bubbles.

Notably, the capillary micro channels (e.g., micro channels 310 and/or pathways 510) may serve a secondary purpose that is additionally useful in distributing the bubbles 190 throughout the liquid flow 380/580. In particular, for a given flow, the smaller diameter of the flow channel may increase the flow velocity such that a given rate of bubbles will be more widely spaced along the flow channel, in addition to being small. In other words, while the flow rate remains relatively the same, the velocity of the liquid through the micro channels may increase, as will be appreciated by those skilled in the art. Accordingly, it may thus be additionally beneficial to fill the entire flow channel 130 with volume-reducing material (suitable to create capillary pathways).

In addition to volume reducers that allow for the flow of liquid and gas, however, certain volume-reducing materials may be impenetrable to bubbles, i.e., preventing any reactant or bubbles from entering the cavities. In this manner, the volume-reducer does not divide bubbles, but instead simply removes cavity volumes in which bubbles may agglomerate into larger bubbles.

According to one or more additional embodiments of the present invention, intolerably sized bubbles that form in the system may be “broken up” (split, divided, busted, burst, etc.). Such breaking up may be performed by a suitable break-up device, as illustrated in simplified example system 600 of FIG. 6. In particular, bubbles 190 that may form within the flow channels may be broken-up by break-up device 610 prior to entry into the liquid receiving device 150 (e.g., after pump 120). The breakup-device may be configured in a variety of suitable manners, such as, e.g., a blender to blend the bubbles, an ultrasonic frequency generator to ultrasonically break bubbles, an atomizer applied to the bubbles, etc., Also, the break-up device 610 may be configured as a series of micro capillaries, through which the bubbles may be directed such that any larger bubbles are forced to divide into smaller bubbles for traversal of the micro capillaries, such as described above (e.g., FIG. 5).

By breaking up the larger bubbles (e.g., intolerably sized), smaller bubbles (e.g., tolerably sized) are created and allowed to flow within the channel 130 to the liquid receiving device 150. Also, in addition to simply reducing the size of the bubbles, i.e., by dividing large bubbles into a plurality of smaller bubbles, the overall surface area of the smaller bubbles may be increased as compared to the surface area of the larger bubble. This increased surface area, along with a suitable solubility factor of the liquid, may allow the smaller gas bubbles to molecularly mix with the liquid; that is, the liquid may absorb the smaller bubbles.

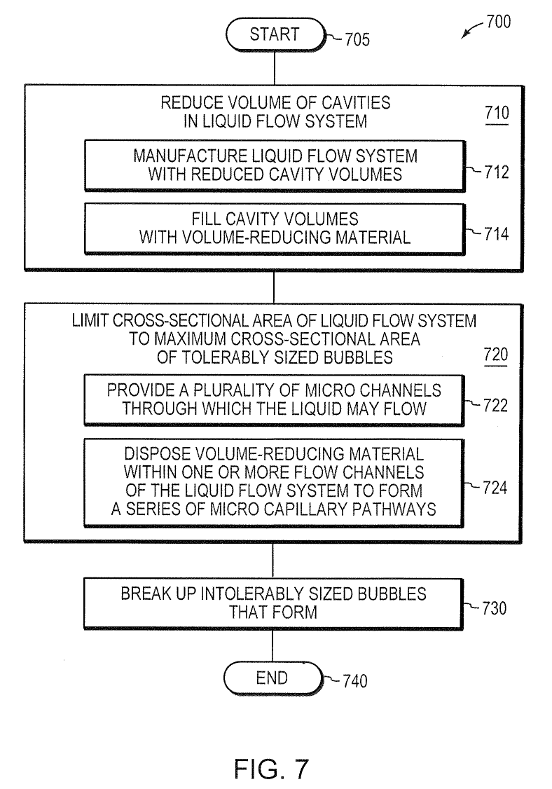

FIG. 7 is a flowchart illustrating a procedure for managing gas bubble size in a liquid flow system in accordance with one or more embodiments of the present invention. The procedure 700 starts at step 705, and continues to step 710, where the volume of cavities are reduced in the liquid flow system 100. For example, in step 712, the liquid flow system may be manufactured with reduced cavity volumes, such as O-volume joints 420, or other means for reducing cavity volume, as described above. Alternatively or in addition, in step 714 cavity volumes may be filled with volume-reducing material 440, such as in certain components (e.g., pump 120) or areas of the flow channels (e.g., joints with excess volume cavities).

In addition, in step 720, the cross-sectional area (210) of the liquid flow system 100 may be limited to a maximum cross-sectional area of tolerably sized bubbles (230), such as limiting diameters of flow channels and any components to a certain value, e.g., 15-20 thousandths of an inch. As described above, one option to limit the cross-sectional area of flow channels is to provide a plurality of micro channels 310 through which the liquid may flow in step 722. Another option in step 724 is to dispose volume-reducing material 540 within one or more flow channels 130 of the liquid flow system 100 to form a series of micro capillary pathways 510.

According to one or more embodiments described herein, and additional step 730 may break up intolerably sized bubbles that form, such as with a break-up device 610 (e.g., blender, ultrasonic frequencies, etc.) as noted above. The procedure 700 ends in step 740, notably with substantially prevented formation of intolerably sized bubbles and aggregation of tolerably sized bubbles into intolerably sized bubbles, accordingly.

In addition, while formation of intolerably sized bubbles and the aggregation of tolerably sized bubbles into intolerably sized bubbles are each substantially prevented by the techniques described above, it may also be helpful to reduce the number of bubbles within the liquid flow system as a whole. For instance, according to one or more embodiments of the present invention, provisions may be in place to accumulate and remove/release any intolerably sized bubbles from the liquid flow system. Thus, fewer bubbles need be managed by the other techniques described herein.

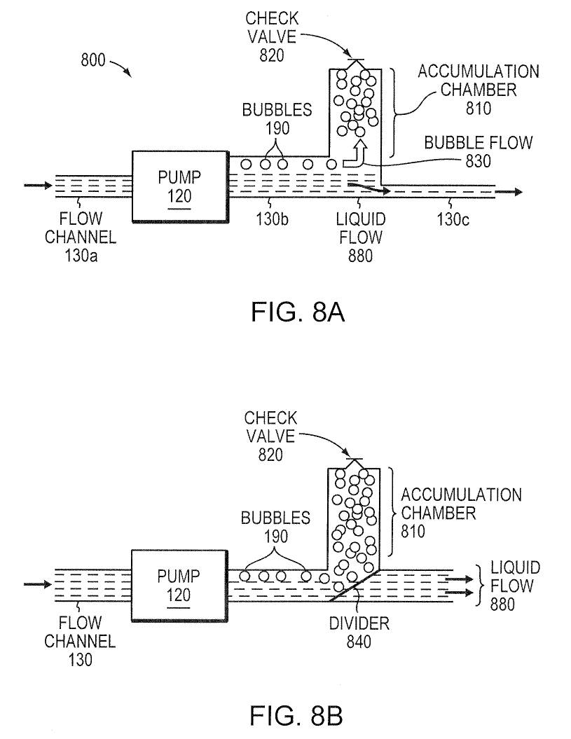

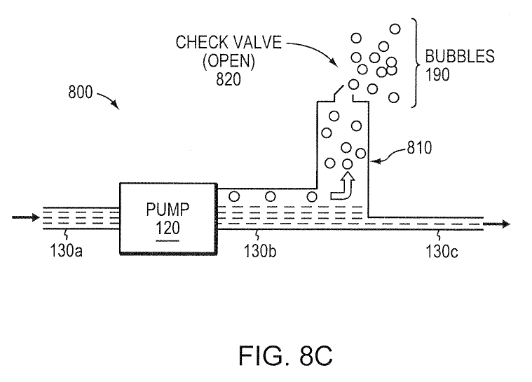

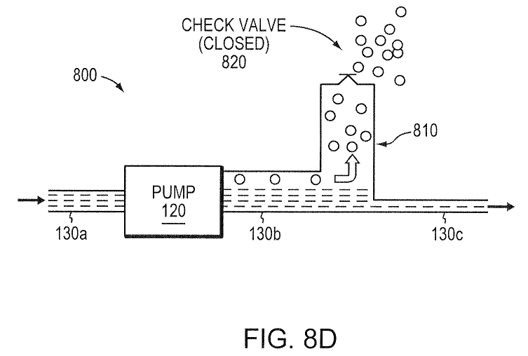

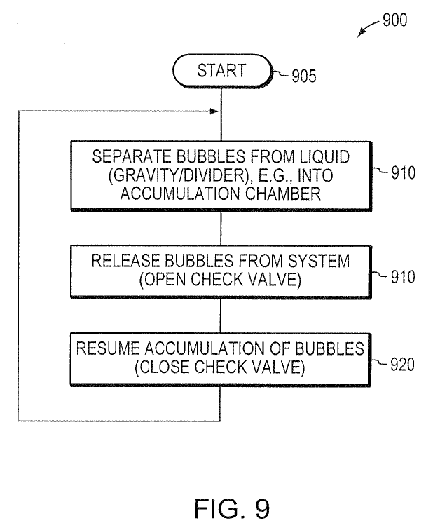

In particular, FIGS. 8A-8D illustrate schematic diagrams of an additional and/or alternative embodiment of the present invention, while FIG. 9 illustrates an example procedure 900 (described in parallel). The procedure 900 starts in step 905, and continues to step 910 where the bubbles are separated from the liquid through gravity and/or dividing mechanisms. For example, in FIG. 8A, the liquid flow system 800 may comprise a pump 120 to force the liquid flow 880 from a flow channel 130a into an illustratively larger flow channel 130b (larger than channel 130a), where one or more bubbles 190 (e.g., tolerably and/or intolerably sized bubbles) may be formed, e.g., by the pump. Due to the lightness of the bubbles (that is, the density of the bubbles as compared to the density of the liquid), the bubbles may hit a wall and flow (830) into an accumulation chamber 810, stopped by a check valve 820. The liquid flow 880 may then continue into the reduced-size flow channel 130c with fewer bubbles (e.g., to other bubble size management devices, as mentioned above). Alternatively, as in FIG. 8B, the flow channel 130 may remain substantially the same size, however a bubble/liquid divider, such as a liquid permeable and gas semi/impermeable membrane, for example, to relocate at least some bubbles into the accumulation chamber 810, regardless of orientation of the system 800.

As shown in FIG. 8C, once the pressure of the accumulated bubbles reaches a pre-determined amount, a check valve 820 (e.g., one way) may be opened (step 915) to release the bubbles out of the liquid flow system (e.g., into the surrounding environment, or to a bubble collection mechanism, not shown). In FIG. 8D, once the pressure inside the collection chamber is reduced below a certain amount (e.g., external pressure to prevent backflow into the system), the check valve 820 may be closed, to allow bubbles to continue to accumulate until subsequent releases in this manner (step 920). This way, the number of bubbles that remain in the liquid flow system may be substantially reduced, which may either be the only bubble management technique in the system, or, illustratively, an additional measure used to manage bubbles and bubble size within the liquid flow system.

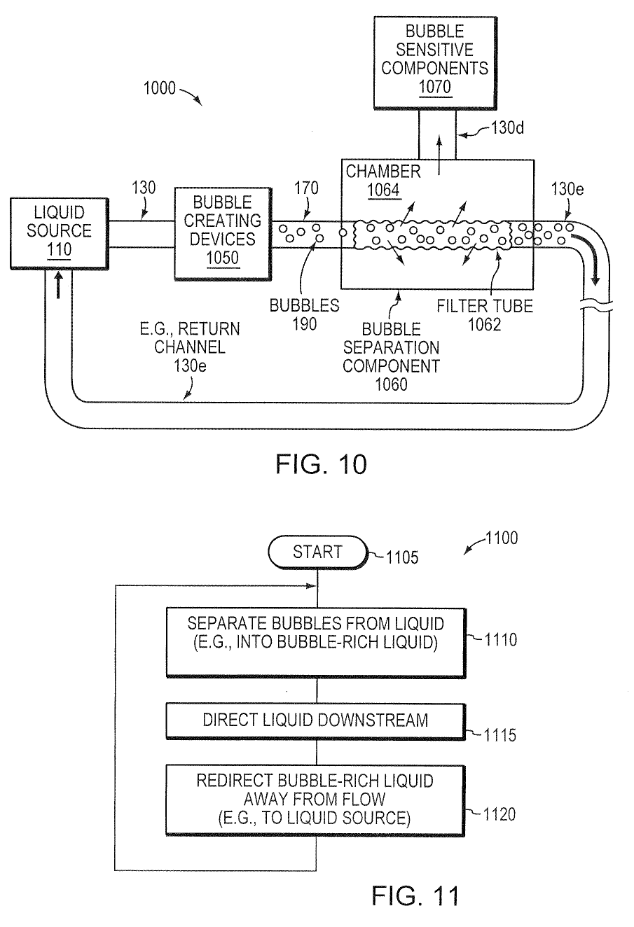

Further, FIG. 10 illustrates a schematic diagram of an additional and/or alternative embodiment of the present invention, while FIG. 11 illustrates an example procedure 1100 (described in parallel). The procedure 1100 starts in step 1105, and continues to step 1110 where the bubbles are separated from the liquid through another example dividing mechanism. For example, in FIG. 10, the liquid flow system 1000 may comprise a liquid source 110 to provide liquid through channel 130 to one or more bubble creating devices 1050 (e.g., pumps, flow channels, etc.). Bubbles 190 may then traverse flow channels 130 into a bubble separation component 1060 having an inlet and two outlets. Illustratively, the component 1060 comprises a liquid flow filter tube 1062, which may be made from a micro porous tube material, such as a liquid permeable and gas semi/impermeable membrane.

When the liquid flows from the flow channel 130 into the tube 1062 of the bubble separation component 1060, due to, for example, surface tension of the bubbles, the bubbles (particularly, intolerably sized bubbles) generally will not pass through walls of the filter tube 1062. As such, only liquid that is basically bubble-free (or at least bubble-lean) passes through the tube 1062 and into a collection chamber 1064, which then feeds to a flow channel 130d to bubble sensitive components 1070 (e.g., sensors, receiving devices, outputs, etc.), as in step 1115.

Bubbles 190 continue to flow down the tube 1062 and eventually reach the outlet of the bubble separation device 1060. Illustratively, the bubbles 190 and an amount of liquid (e.g., having a higher concentration of bubbles) traverse flow channel 130e in step 1120, e.g., on a return path to the liquid source 110, which may reuse the unused liquid, and may have provisions for collecting or removing the bubbles 190 (e.g., gas release outlets, collection volumes/voids created as liquid is removed from the source, etc.). (Notably, other flow channels 130e may also be used, such as sending the bubble-rich liquid to bubble removal devices before returning the liquid to the bubble sensitive components 1070.) In this manner, bubbles 190 may be removed regardless of orientation of the system 1000.

Advantageously, the novel system manages bubbles in a liquid flow system. In particular, by substantially preventing formation of intolerably sized bubbles and aggregation of tolerably sized bubbles into intolerably sized bubbles, the novel technique provides solutions to various problems associated with bubbles in liquid flow systems. For example, finely divided and distributed bubbles in the liquid reactant flow of a fuel cell have been demonstrated to reduce power fluctuations of given gas amounts within the liquid as contrasted with such amounts of gas agglomerating into one or more large bubbles that pass at one time through the system. In addition, the highly distributed and finely divided bubbles (e.g., homogenized with the liquid) create smaller perturbations on flow sensing of the liquid flow, enabling more precise control and measurement sensitivity. Also, by removing intolerably sized bubbles from the system according to one or more aspects of the invention, fewer intolerably sized bubbles need be managed by other techniques described herein.

While there has been shown and described an illustrative embodiment that delivers liquid to a liquid receiving device, it is to be understood that various other adaptations and modifications may be made within the spirit and scope of the present invention. For example, the invention has been shown and described herein using a fuel cell (or other electrochemical energy conversion device) as receiving device 150. However, the invention in its broader sense is not so limited, and may, in fact, be used with other devices, and is not limited to use with electrochemical energy conversion devices. For example, any liquid flow system that is concerned with flow of the liquid and gas bubbles that may occur within the liquid. In particular, certain devices that are sensitive to bubbles in liquid, such as for flow rates and/or pressure monitoring of the fluid, or simply to reduce bubbles for other reasons (e.g., paint systems, medical devices, power plants, etc.), may also make use of the novel techniques described herein. Accordingly, any references to size (e.g., “micro capillaries”) are merely relative and scaled within a particular system, for example, in accordance with the size of tolerably sized bubbles suitable for a respective system.

The foregoing description has been directed to specific embodiments of the invention. It will be apparent, however, that other variations and modifications may be made to the described embodiments, with the attainment of some or all of the advantages of such. Accordingly this description is to be taken only by way of example and not to otherwise limit the scope of the invention. Therefore, it is the object of the appended claims to cover all such variations and modifications as come within the true spirit and scope of the invention.

What is claimed is:

1. A method for managing gas bubbles in a liquid flow system, the method comprising:
reducing a volume of cavities in the liquid flow system; and
limiting a cross-sectional area of the liquid flow system to a maximum cross-sectional area of tolerably sized bubbles;
wherein reducing the cavity volumes and limiting cross-sectional areas substantially prevent formation of intolerably sized bubbles and aggregation of tolerably sized bubbles into intolerably sized bubbles.

2. The method as in claim 1, further comprising:
breaking up intolerably sized bubbles that form.

3. The method as in claim 2, wherein breaking up is selected from a group consisting of: blending bubbles; ultrasonically breaking bubbles; applying an atomizer to the bubbles; and directing the bubbles through a series of micro capillaries.

4. The method as in claim 1, further comprising:
filling the cavity volumes with a volume-reducing material.

5. The method as in claim 4, wherein the volume-reducing material is impenetrable to bubbles.

6. The method as in claim 1, wherein limiting further comprises:
providing a plurality of micro channels through which the liquid may flow.

7. The method as in claim 1, further comprising:
disposing volume-reducing material within one or more flow channels of the liquid flow system, the volume-reducing material within the flow channels forming a series of micro capillary pathways.

8. The method as in claim 1, wherein reducing further comprises:
manufacturing the liquid flow system with reduced cavity volumes.

9. The method as in claim 1, further comprising:
accumulating bubbles of the liquid flow system in an accumulation chamber; and
releasing the accumulated bubbles from the accumulation chamber out of the liquid flow system.

10. The method as in claim 9, wherein releasing further comprises:
opening a one-way check valve to release the accumulated bubbles.

11. The method as in claim 1, further comprising:
separating bubbles from liquid of the liquid flow system to form bubble-rich liquid and bubble-lean liquid;
directing the bubble-lean liquid downstream into the liquid flow system; and
redirecting the bubble-rich liquid away from the liquid flow system.

12. The method as in claim 11, wherein redirecting further comprises:
returning the bubble-rich liquid to a liquid source of the liquid flow system.

13. A liquid flow system to manage gas bubbles, the system comprising:
one or more cavities having a volume;
volume-reducing material substantially filling the volume of the cavities to reduce the cavity volume; and
one or more liquid flow channels having cross-sectional areas limited to a maximum cross-sectional area of tolerably sized bubbles;
wherein the reduced cavity volumes and limited cross-sectional areas substantially prevent formation of intolerably sized bubbles and aggregation of tolerably sized bubbles into intolerably sized bubbles.

14. The system as in claim 13, further comprising:
a break-up device configured to break up intolerably sized bubbles that form.

15. The system as in claim 14, wherein the break-up device is selected from a group consisting of: a blender; an ultrasonic frequency generator; an atomizer; and a series of micro capillaries.

16. The system as in claim 13, wherein the volume-reducing material is impenetrable to bubbles.

17. The system as in claim 13, wherein the volume-reducing material is selected from a group consisting of: frit; open-cell foam; fibrous material; and sintered polyethylene.

18. The system as in claim 13, wherein the one or more flow channels are manufactured with reduced cavity volumes.

19. The system as in claim 13, wherein the volume-reducing material comprises a grain size substantially smaller than the tolerably sized bubble.

20. The system as in claim 13, wherein the one or more flow channels comprise a plurality of micro channels.

21. The system as in claim 13, wherein the volume-reducing material is disposed within the one or more flow channels, the volume-reducing material within the flow channels forming a series of micro capillary pathways.

22. The system as in claim 13, further comprising:
an electrochemical energy conversion device adapted to receive liquid reactant from the liquid flow channels.

23. The system as in claim 22, wherein the electrochemical energy conversion device is a direct oxidation fuel cell (DOFC).

24. The system as in claim 13, further comprising:
an accumulation chamber configured to allow accumulation of bubbles of the liquid flow system; and
a one-way check valve to release the accumulated bubbles from the accumulation chamber out of the liquid flow system.

25. The system as in claim 13, further comprising:
a bubble separation component having a filter tube and a collection chamber, the filter tube configured to allow liquid to permeate the tube and enter the collection chamber, the tube further configured to substantially prevent bubbles from permeating the tube;
a first outlet liquid flow channel from the bubble separation component to direct bubble-lean liquid from the collection chamber downstream into the liquid flow system; and
a second outlet liquid flow channel from the bubble separation component to redirect bubble-rich liquid from the filter tube away from the liquid flow system.

26. The system as in claim 25, further comprising:
a return liquid flow channel from the second outlet liquid flow channel to return the bubble-rich liquid to a liquid source for the liquid flow system.

27. A liquid flow system to manage gas bubbles, the system comprising:
a pump with one or more cavities having a volume;
volume-reducing material substantially filling the volume of the one or more cavities to prevent formation of intolerably sized bubbles and aggregation of tolerably sized bubbles into intolerably sized bubbles; and
one or more liquid flow channels having cross-sectional areas limited to a maximum cross-sectional area of tolerably sized bubbles to prevent formation of intolerably sized bubbles and aggregation of tolerably sized bubbles into intolerably sized bubbles.

28. The system as in claim 27, further comprising:
a liquid receiving device; and
a flow path with one or more zero volume joints between the pump and the liquid receiving device.

29. The system as in claim 27, wherein the pump is an electroosmotic pump and the volume reducing material is frit.

30. The system as in claim 29, wherein the frit fills one or more exit plenums of the electro kinetic pump.

31. The system as in claim 27, further comprising:
a break-up device configured to break up intolerably sized bubbles that form.

32. A liquid flow system to manage gas bubble size, the system comprising:
one or more cavities having a volume;
volume-reducing material substantially filling the volume of the cavities to reduce the cavity volume; and
wherein the reduced cavity volumes substantially prevent formation of intolerably sized bubbles and aggregation of tolerably sized bubbles into intolerably sized bubbles.

33. A liquid flow system to manage gas bubbles, the system comprising:
one or more liquid flow channels;
an accumulation chamber configured to allow accumulation of bubbles from at least one of the liquid flow channels; and
a one-way check valve to release the accumulated bubbles from the accumulation chamber out of the liquid flow system.

34. A liquid flow system to manage gas bubbles, the system comprising:
one or more liquid flow channels;
a bubble separation component having a filter tube and a collection chamber, the filter tube configured to allow liquid to permeate the tube and enter the collection chamber, the tube further configured to prevent bubbles from permeating the tube;
a first outlet liquid flow channel from the bubble separation component to direct bubble-lean liquid from the collection chamber downstream into the liquid flow system; and
a second outlet liquid flow channel from the bubble separation component to redirect bubble-rich liquid from the filter tube away from the liquid flow system.

35. The system as in claim 34, wherein the bubble-lean liquid is bubble-free.
